(19) United States
(12) Patent Application Publication
(10) Pub. No.: US 2013/0330537 A1
(43) Pub. Date: Dec. 12, 2013

(54) Porous Ceramic Foam Granules and Method of Producing the Same

(71) Applicant: Stefanie SHIELS, San Antonio, TX (US)

(72) Inventor: Stefanie SHIELS, San Antonio, TX (US)

(73) Assignee: GenOsteo, Inc., San Antonio, TX (US)

(21) Appl. No.: 13/490,349

(22) Filed: Jun. 6, 2012

(51) Int. Cl. B29C 67/04

(52) U.S. Cl. CPC B29C 67/04
USPC 428/312.8; 264/643

(57) ABSTRACT

Materials and methods of producing materials for scaffolds to facilitate growth of bone tissues. Porous ceramic materials are produced by a template coating method. Polymeric foam is processed to produce treated foam. Polymer solution, ceramic powder, dispersant, and drying agent are combined, mixed, and sonicated in a multi-step process to achieve a uniform mixture. In a first coating application, treated foam and ceramic slurry are processed until visibly homogeneous and fully reticulated, then sintered to form porous ceramic materials. Through a second multi-step process, a second ceramic slurry is prepared. In a second coating application, the porous ceramic materials are coated with the second slurry, blocked pores cleared, and the material dried and sintered to form a finalized porous sintered ceramic material. The fully reticulated scaffold material provides ceramic foam scaffolds similar to trabecular bone composition and structure, providing consistent mechanical integrity and porosity for regeneration of functional bone tissues.

### BACKGROUND OF THE INVENTION

1. Field of the Invention

The present invention relates generally to materials used as scaffolds for facilitating the growth of biological tissues. The present invention relates more specifically to a sintered ceramic material with interconnecting pores a method for making the material of a predefined shape suitable for use as scaffolding for the regeneration of bone tissues.

2. Description of the Related Art

In tissue engineering for bone regeneration, a polymeric or ceramic scaffold is often a key component that serves as a platform for cell interactions and guide for bone formation while also providing structural support to the newly formed tissue. To perform this function, the scaffold for bone regeneration should meet certain criteria, including, but not limited to, biocompatibility, resorbability, osteoconductivity, permeability to allow for fluid exchange and pore size to account for cellular infiltration.

Much research has been reported in recent years in the use of polymeric and ceramic biomaterials for producing scaffolds for bone tissue regeneration. However, no single material or fabrication technique optimal for bone tissue regeneration has been identified. Current materials and techniques have met with varying success, yet each has inherent limitations that are still to be addressed.

As mentioned previously, scaffolds for bone tissue regeneration should be biocompatible, bioresorbable, contain an open-pore architecture and be mechanically similar to the bone repair site. Restoration of natural bone function is dependent on establishing conditions where materials and cells are combined to create regenerative environment. This can be accomplished, in part, by closely matching the composition, structure, chemistry, and mechanical properties of the implant to that of natural bone. The inorganic portion of natural bone is composed of biological apatite, rich in calcium and phosphate. The architecture of the scaffold is similar to that of trabecular bone and when using a calcium phosphate ceramic, the composition resembles the inorganic phase of bone tissue. Additionally, the architecture of the scaffolds (pore size, porosity, interconnectivity and permeability) should be adequate to allow for favorable transport/diffusion of ions, nutrients and wastes, which is important for osteoconduction and tissue growth.

Thus far, a number of manufacturing methods for the production of porous materials have been developed. Among these methods, the polymeric foam replication method has received particular attention because it can provide predictable structure with very high porosity and good interconnections between pores. In this method, a fully reticulated foam is used as a template to produce scaffolds with a highly controlled and precise pore size distribution. These properties would be expected to promote bone in-growth and the vascularization of newly formed tissue, but also to result in a decrease in the strength of the materials.

Various ceramics can be used for the preparation of such scaffolds. Among these varieties are included multiple types of calcium phosphates (such as hydroxyapatite (HAp), tricalcium phosphate (TCP), amorphous calcium phosphate (ACP), tetracalcium phosphate (TTCP), monocalcium phosphate (MCP), and octacalcium phosphate (OCP)) and other ceramics such as calcium sulfate, aluminum oxide, silicon dioxide, and zirconium dioxide. Among the various forms of calcium phosphate ceramics, HAp has gained attention because of usage in bone grafting, resulting from excellent osteoconductive and bioactive properties. HAp is thermodynamically the most stable crystalline phase of calcium phosphate in physiological conditions and encourages attachment of extracellular proteins and cells. The various ceramics each have a unique resorption rates, which can be tuned by blending multiples forms into the scaffold, such as tricalcium phosphate and hydroxyapatite Current laboratory mechanisms only allow for the manual coating of the foam pieces, leaving inconsistencies in the slurry preparation and coating process. A method is necessary that can easily be reproduced as well as be scaled to meet industry production needs. This method should also be able to be tuned to meet the specific needs of the scaffold, to include pore size, strut thickness, and ceramic chosen.

### SUMMARY OF THE INVENTION

The present invention therefore provides a template coating method to create porous sintered ceramic materials of a predefined size and shape which contains interconnected pores and maintains high porosity. This method creates porous ceramic material in a way that is repeatable, scalable, and tunable to the specific needs of the scaffold. In this method, polymeric foam is immersed in sodium hydroxide/de-ionized water, compressed to remove air bubbles, and sonicated to treat the foam material for ceramic coating. The foam is thoroughly rinsed, compressed, and dried to produce the treated foam.

In order, an aqueous polymer solution, a ceramic powder, and a dispersant are combined in a mixing cup. The slurry is thoroughly mixed to a homogeneous consistency and then sonicated in a bath-style sonicator. An organic solvent (drying agent) is added to the slurry and it is mixed again. This ceramic slurry is sonicated and mixed again to ensure homogenous consistency. The first slurry is then ready for the first coating step.

In a first coating application, treated foam pieces and ceramic slurry are mixed twice until the coatings are uniform on the treated foam. Blocked pores are cleared with air until the coated foam is fully reticulated. The coated foam is dried overnight then processed with a specific sintering cycle, removed from the furnace and stored until the second coating application.

A second ceramic slurry is prepared which is less viscous than the first slurry. As in the first slurry preparation, an aqueous polymer solution and a sifted ceramic powder are combined in a mixing cup with a dispersant and mixed to create a homogeneous slurry. A drying agent is added, the slurry is mixed again and sonicated. The slurry is mixed once again and is then ready for the second coating step.

In a second coating application, the dry, sintered ceramic material from the first coating are placed in a sieve and small amounts of slurry are poured on top of them, lightly and carefully shaken to allow the slurry to pass through the pores, and blocked pores are cleared with compressed air. The coated ceramic foam material is dried overnight then processed with a specific sintering cycle, removed from the furnace and stored in a dry location. The purpose of the second coating step is to fill any holes in the surface of the structure, to round the strut surface, and to improve the mechanical integrity of the granules.

The ceramic foam is then used as bone-like scaffolds similar in composition and structure to the inorganic portion of trabecular bone. These scaffolds mimic the natural architecture of trabecular bone, may be prepared to fit into any size and shape for variety of uses, and promote regeneration of functional bone tissues.

### BRIEF DESCRIPTION OF THE DRAWINGS

FIG. 1 is a flow chart showing the overall method of producing the ceramic foam granules of the present invention.

FIG. 2 is a flow chart of a sub-process of the method of the present invention involving the preparation of the foam material.

FIG. 3 is a flow chart of a sub-process of the method of the present invention involving the preparation of a first slurry.

FIG. 4 is a flow chart of a sub-process of the method of the present invention involving the production of a first coating.

FIG. 5 is a flow chart of a sub-process of the method of the present invention involving the preparation of a second slurry.

FIG. 6 is a flow chart of a sub-process of the method of the present invention involving the production of a second coating.

FIG. 7 is a flow chart of a sub-process of the method of the present invention involving the typical sintering cycle process.

FIG. 8 is a partially schematic diagram disclosing the various manufacturing system components required for production of the ceramic foam granules of the present invention.

FIG. 9A is an image of the open-pore structure of the implant of the present invention.

FIG. 9B is a zoomed in image of a section of the surface of the implant of FIG. 9A, showing the individual hydroxyapatite particles fused together.

### DETAILED DESCRIPTION OF THE PREFERRED EMBODIMENTS

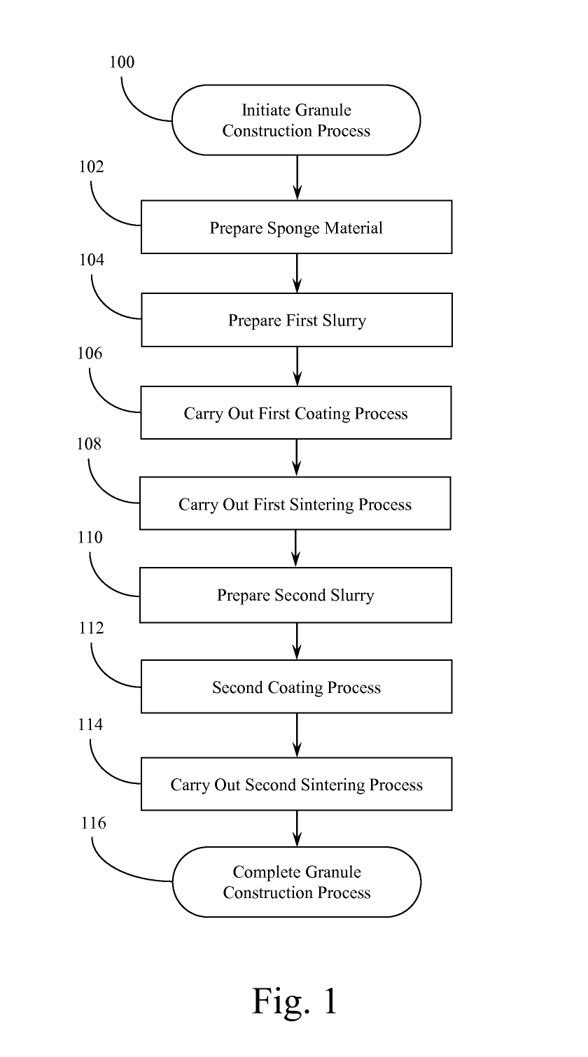

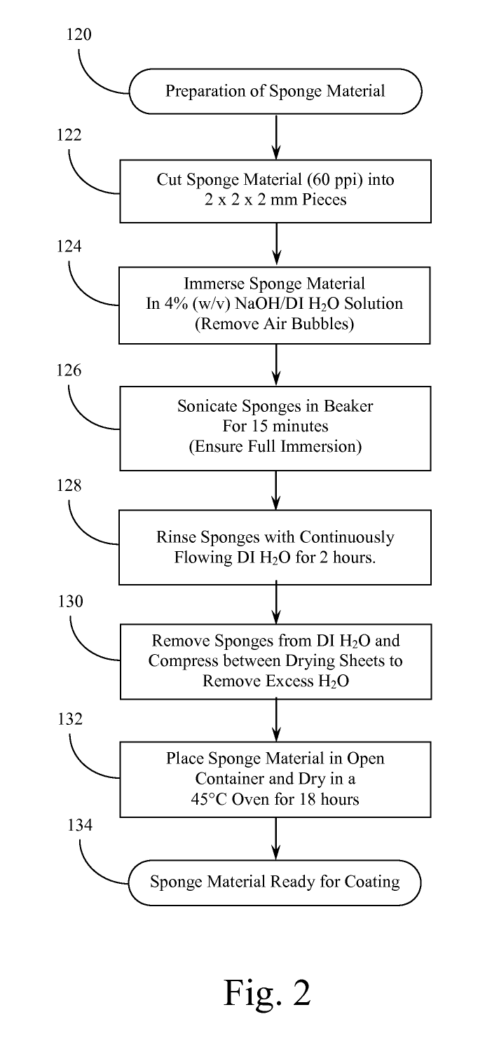

Reference is made first to FIG. 1 for a description of the overall manufacturing process for producing the porous sintered ceramic material of the present invention. FIG. 1 provides an overview of the major sub-processes utilized in conjunction with the manufacturing method of the present invention. FIGS. 2-7 thereafter describe in more detail the individual steps associated with carrying out each of the sub-processes within the overall method of the present invention.

As FIG. 1 discloses, the process of porous sintered ceramic material construction is initiated at Step 100. A first process Step 102 involves the preparation of the foam material to be utilized in the porous sintered ceramic material construction. Step 104 involves the sub-process of preparing a first slurry for use in the coating process. The first coating process is carried out at sub-process Step 106. A first sintering process is carried out at sub-process Step 108.

As the overall construction process of the present invention is notably a two coating manufacturing method, the first coating sub-process is followed by a second similar, but not identical coating sub-process. A second slurry is prepared at sub-process Step 110. This is followed at sub-process Step 112 with a second coating process. A second sintering is carried out at sub-process Step 114. Once the second sintering is complete, the overall porous sintered ceramic material construction process is complete at Step 116, and the product resulting from the manufacturing method may be packaged and used for its intended purpose.

FIG. 2 represents the sub-process associated with the preparation of the foam material utilized in forming the scaffolding structure of the present invention. The sub-process beginning at Step 120 is carried out initially by the selection of the polyurethane or similar foam to be utilized in the formation of the template for the scaffolding material. The foam itself should be a fully reticulated foam having 25-100 pores per inch (ppi). The pores may preferably be in the range of 100-600 microns across. The polymer foam used for making the porous sintered ceramic structures can be composed of different foams such as polyurethane foam or vinyl polymer foam of varying pore size or composition.

Step 122 involves sizing the foam material into predetermined shapes and sizes. For example, for a granular material, the foam is sized to approximately 2×2×2 mm (alternatively in the range of 1-3 mm) pieces for the granule templates. This foam material is then immersed at Step 124 in a 4% (w/v) NaOH/DI solution. Any air bubbles that are released as part of the immersion process may be gently displaced from the foam material and allowed to escape the solution.

The sodium hydroxide/distilled water solution (NaOH/DI) serves to effectively clean and roughen the foam material in preparation for the first coating. The cleaning solution comprises an aqueous solution of pH 9 to pH 14 and may include sodium hydroxide, ammonium hydroxide, and potassium hydroxide.

Step 126 involves sonicating the foams in a beaker for 15 minutes while ensuring full immersion. This step cleans and fully removes the particles that were etched out. The foam material templates are then rinsed with continuously flowing deionized water (DI) for approximately 2 hours at Step 128.

At Step 130 the foams are removed from the distilled water and compressed between drying sheets to remove the excess water. As the foam material remains resilient at this stage of the process, the compression and drying of the foam material does not alter their structural characteristics. Once again, the process for initially cleaning the foam material facilitates the subsequent adhesion of the slurry to all surfaces of the foam.

At Step 132 the foam material is placed in an open container and dried in a 45° C. oven for approximately 18 hours. Finally, at Step 134 the foam material preparation is complete and the material is now ready for a first coating.

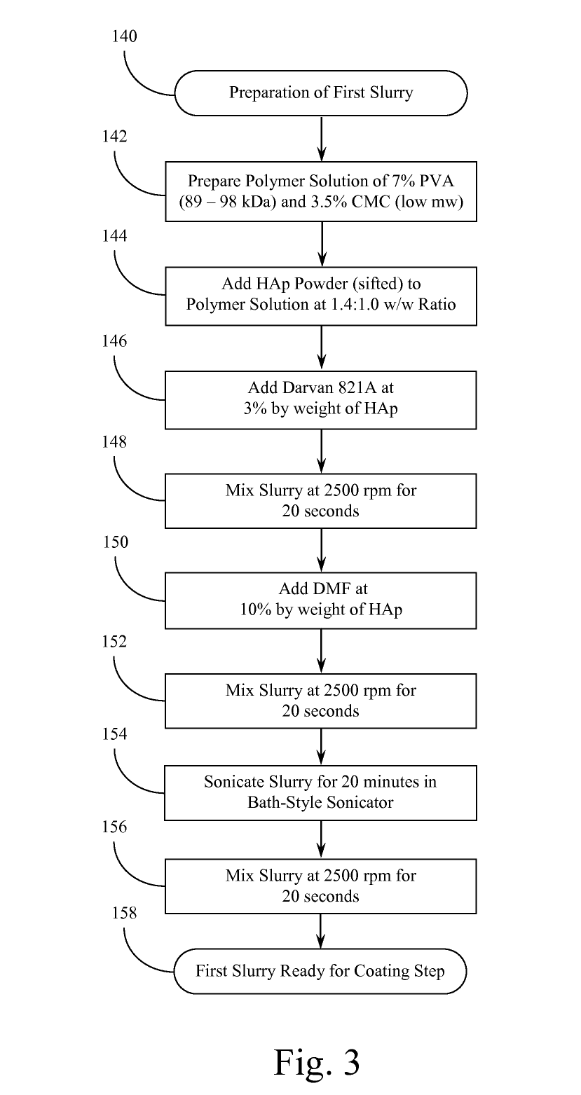

Reference is next made to FIG. 3 for a detailed description of the sub-process of preparing the first slurry for the overall manufacturing method. The porous ceramic material can be formulated with a variety of ceramics to achieve desired properties. These properties include, but are not limited to, resorption rate, bioactivity, and strength. By altering the ceramic used, the slurry ratios and coating ratios would be altered. The following are examples of how this alteration would be carried out. The slurry can be prepared with various ceramic powders, to include but not limited to calcium phosphates such as hydroxyapatite (HAp), tricalcium phosphate (TCP), amorphous calcium phosphate (ACP), tetracalcium phosphate (TTCP), monocalcium phosphate (MCP), and octacalcium phosphate (OCP) and other ceramics such as calcium sulfate, aluminum oxide, silicon dioxide, and zirconium dioxide. To create specific properties, it is also possible to create blends of ceramic powders.

By using alternate ceramic powders with differing densities, diameters, and surface areas, the dissolved polymers and powder-to-liquid ratios must be altered to accompany these changes. For example, a scaffold constructed from alumina powder of the same diameter and surface area as the currently used hydroxyapatite powder, which has a higher density than hydroxyapatite, would require an alteration in the powder-to-liquid ratio of the slurry, which uses mass as its unit of measure. To achieve a slurry with the same solids content by volume, the amount of alumina powder would be increased, resulting in a need to increase the dissolved polymers and drying agent. The drying agent may be dimethylformamide or dimethylsulfoxide. In addition, increasing the carboxymethylcellulose would increase the viscosity of the slurry. This, in turn, would create thicker coatings on the foam surface.

Referring to FIG. 3, initiation of the first slurry preparation, using HAp as the ceramic of choice as an example, is at Step 140. Initially, a polymer solution of a 7% polyvinyl alcohol (PVA) having a molecular weight of approximately 89-98 kDa and 3.5% carboxymethylcellulose (CMC) having a low molecular weight, is prepared at Step 142. The polymer solution may include polyvinyl alcohol, carboxymethylcellulose, starch, polyvinyl butyral, and polyethylene glycol.

This is followed at Step 144 by the addition of the sifted hydroxyapatite (HAp) powder. The HAp powder is added to the solution at a 1.4:1.0 w/w powder to solution ratio. The HAp powder preferably comprises a spherical particulate having a 20-40 nm diameter.

At Step 146, Darvan 821A (an aqueous solution containing 39.5-40.5% ammonium polyacrylate dispersant) is added at a rate of 3% by weight of HAp. The dispersant may be ammonium polyacrylate or ammonium polymethacrylate. At Step 148, the slurry is mixed in a dual action mixer (such as a FlackTek SpeedMixer or similar) for 20 seconds at 2500 rpm. At Step 150, a quantity of dimethylformamide (DMF) is added at a 10% by weight of HAp. At Step 152, the slurry is mixed again at 2500 rpm for 20 seconds. The DMF provides a drying agent for the slurry. At Step 154, the slurry is sonicated for 20 minutes in a bath style sonicator in order to break up all of the particles. This is followed by Step 156 where the slurry is again mixed at 2500 rpm for 20 seconds. Finally, at Step 158, the first slurry is ready for the first coating step.

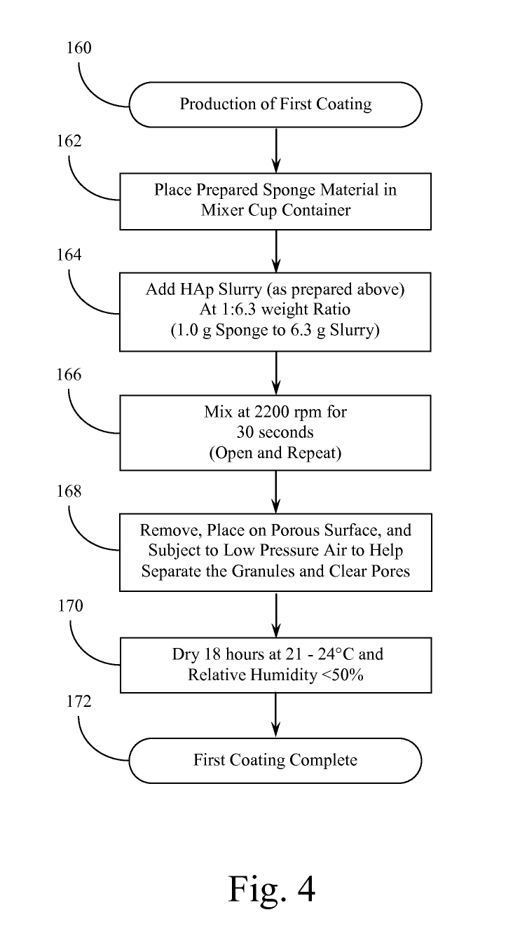

FIG. 4 describes in greater detail the sub-process of the production of a first coating on the treated foam template prepared as described above. The currently proposed method requires a specific ratio of slurry-to-foam material which is based on weight. Using a slurry composed of alumina, for example, which has a higher density, the ratio of slurry-to-foam would increase to get the same coverage on the foam. In addition, the amount of slurry added to the foam can be increased or decreased to deposit thicker or thinner coatings.

Referring to FIG. 4, the first coating production process begins at Step 160. Step 162 involves the placement of the prepared foam material in a mixing cup container. At Step 164, the HAp slurry (as prepared above) is added to the foam material at a rate of 1:6.3 w/w (1.0 g foam to 6.3 g slurry, for example). The foam/slurry combination is mixed at 2200 rpm for 30 seconds at Step 166. It is preferable to open the mixing container during mixing to verify the consistency of the mixture and then to repeat the mixing at 2200 rpm for 30 seconds. Completeness of the mixing process will be evidenced by the absence of any large white areas of material indicating a uniform composition with the slurry generally coating all parts of the foam material.

At Step 168, the coated foam material is removed and placed on a porous surface. The material is then subjected to a flow of pressurized air to help separate the granules from each other and to clear the pores of the granule templates, in order to once again become fully reticulated. At Step 170, the material is allowed to dry for approximately 18 hours at 21°-24° C. in an environment having a relative humidity of less than 50%. After drying occurs, the first coating process is complete at Step 172.

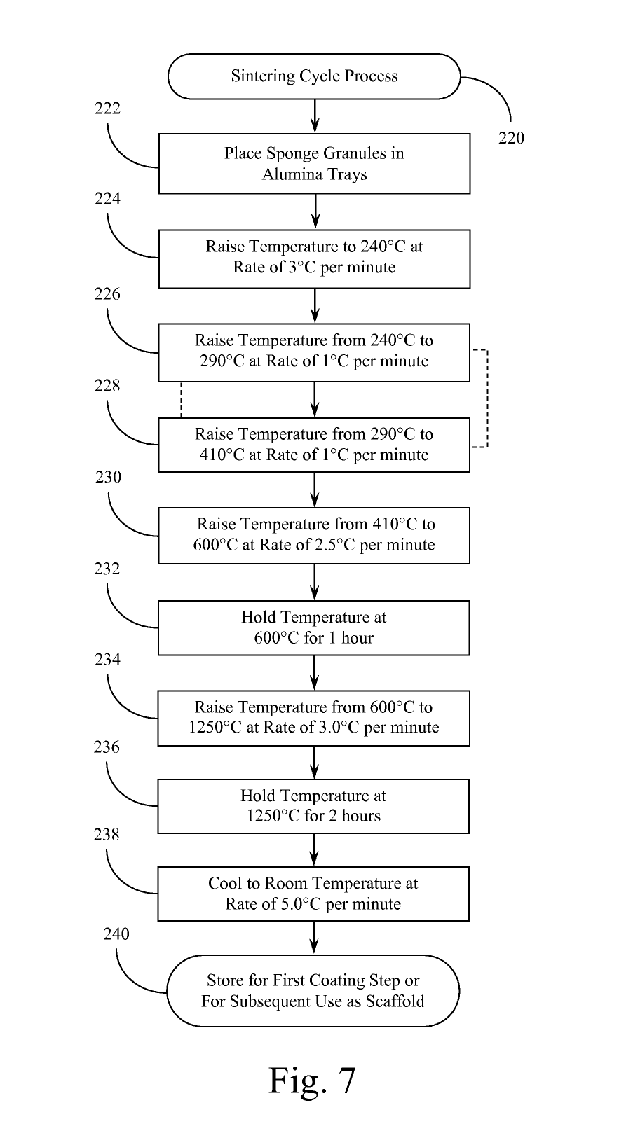

Reference is next made ahead to FIG. 7 which describes in a single flow chart the basic sintering cycle process carried out twice in the overall method of the present invention. As shown in FIG. 1, a first sintering process occurs subsequent to the first coating process. The sintering cycle process, beginning at Step 220 shown in FIG. 7, is initiated at Step 222 wherein the coated and dried foam material is placed in tray suitable for sintering up to.

The trays must be able to withstand the high temperatures of the sintering process and not become chemically involved in the reactions initiated at such high temperatures. The alumina trays containing the ceramic coated foam material is placed and positioned within a programmable oven. Initially, the temperature is raised at Step 224 to approximately 240° C. at a rate of 3° C. per minute. This is followed at Step 226 by a period of increasing the temperature from 240° C. to 290° C. at a rate of 1° C. per minute. At Step 228, the temperature is raised from 290° C. to 410° C. at a rate of 1° C. per minute. Subsequently, the temperature is raised at Step 230 from 410° C. to 600° C. at a rate of 2.5° C. per minute. The temperature is then held at Step 232 at 600° C. for approximately one hour.

After a temperature hold at 600° C., the temperature is again raised at Step 234 from 600° C. to 1250° C. at a rate of 3° C. per minute. A second hold at 1250° C. occurs at Step 236 for approximately two hours. The temperature may be held between 1200 and 1600° C. for 2 to 5 hours. The heating steps require holding at a temperature equal to or greater than the transition temperature of the ceramic powder. Sintering occurs, and the particles of hydroxyapatite fuse to form a stable block. Then, at Step 238, the oven and the porous hydroxyapatite material is allowed to cool to room temperature at a rate of 5° C. per minute. This sintering cycle provides the optimum schedule for the process by slowly burning off the binders, the dispersant and eventually the polymeric foam.

The resulting ceramic foam is a replica of the polymeric foam. Once at room temperature, the porous sintered ceramic material may be stored at Step 240, preferably at an elevated temperature of approximately 45° C. temperature until the second coating process is ready to be carried out. This elevated temperature is used to prevent the collection of moisture from the atmosphere.

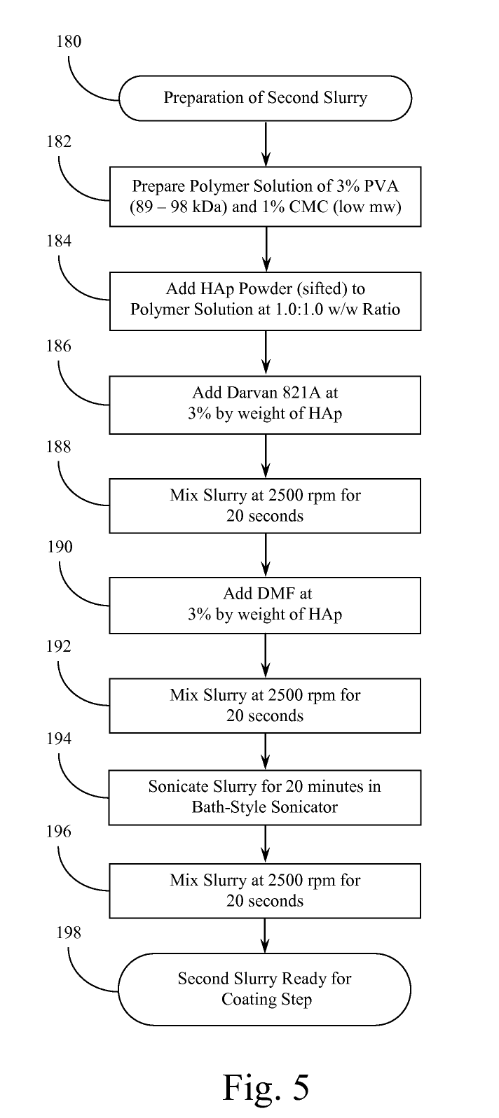

Reference is now made back to FIG. 5 for a detailed description of the preparation of the second slurry initiated at Step 180 within the overall process of the present invention. The main purpose of the second slurry is to fill any holes in the struts or micro-pores on the surface in order to provide a rounded strut as well as additional mechanical strength to the structure. The second slurry is a less viscous composition than the first slurry and will provide a coating of approximately 5-20 microns in thickness. The second slurry preparation begins with the preparation at Step 182 of the polymer solution, this time comprising a 3% PVA and 1% CMC solution. This is followed at Step 184 with the addition of the HAp powder (again sifted) to the polymer solution at a 1.0:1.0 w/w ratio. At Step 186, Darvan 821A is added at a rate of 3% by weight of HAp. The second slurry is mixed at Step 188 at 2500 rpm for 20 seconds, once again in a dual action mixer.

DMF is added at Step 190 at the rate of 3% by weight of HAp. A smaller quantity of DMF is required in the second slurry compared to the first step because the prevention of cracks in the coating are not as crucial as the first coating step. The slurry is again mixed at 2500 rpm for 20 seconds at Step 192. The slurry is sonicated at Step 194 for 20 minutes in a bath style sonicator. The slurry is again mixed at Step 196 at 2500 rpm for 20 seconds. Step 190 represents the completed preparation of the second slurry ready for the second coating step.

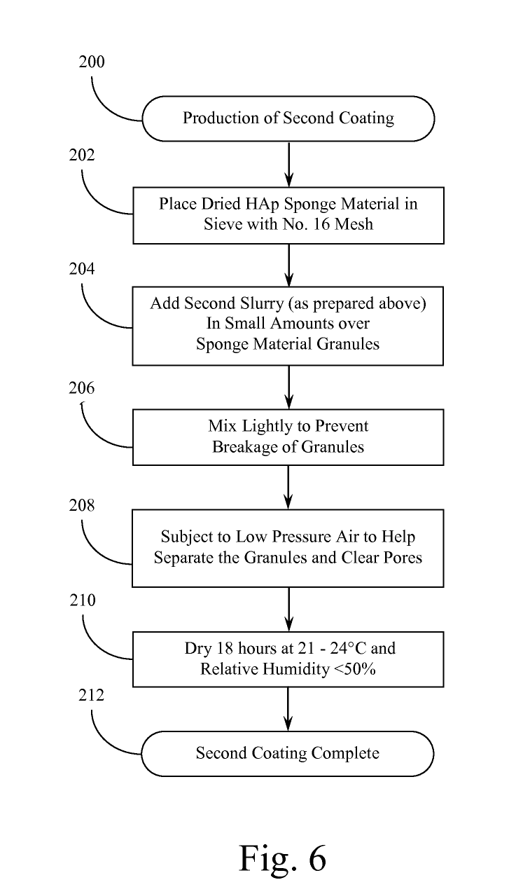

FIG. 6 describes in greater detail, beginning at Step 200, the production of the second coating. Step 202 involves placing a thin layer of the dried porous sintered HAp material prepared previously onto a sieve having a No. 16 mesh or similar. The granules are placed in a single layer within the sieve, and piled no more than two granules thick. Step 204 involves the addition of the second slurry (as prepared above) in small amounts (by pipette or the like) over the porous sintered HAp material. Some care is taken in the process of adding the second slurry to the granules as the first sintering process has produced material that is brittle to the touch. Step 206 therefore involves shaking the granules to facilitate the process of the second coating without resulting in significant breakage of the porous ceramic material.

Step 208 involves once again subjecting the coated ceramic material (while on the sieve or other porous surface) to low pressure air to help separate the granules and clear the pores. Step 210 then involves drying the granules for approximately 18 hours at 21°-24° C. in an environment having a relative humidity of less than 50%. Step 212 thereby completes the second coating process allowing the manufacturing process to proceed once again to a sintering cycle. The finalized porous sintered ceramic structures range in size from 0.5 mm to 2000 mm. and the shape comprises one or more shapes selected from the group consisting of spherical, cuboidal, star-shaped, egg-shaped, cylindrical, plates, and screws. The pores of the finalized porous sintered ceramic structures range in size from 100 to 500 microns. The detailed sintering cycle process shown in FIG. 7 beginning at Step 220 is therefore repeated with the final Step 240 in the sintering process now the precursor step for packaging the material for subsequent use as scaffolding material for bone tissue. For granular material, for example, it is anticipated that 10-30 cc volumes of the material may be separately packaged in such a manner as to once again prevent the absorption of moisture from the air until such time as the material is to be used.

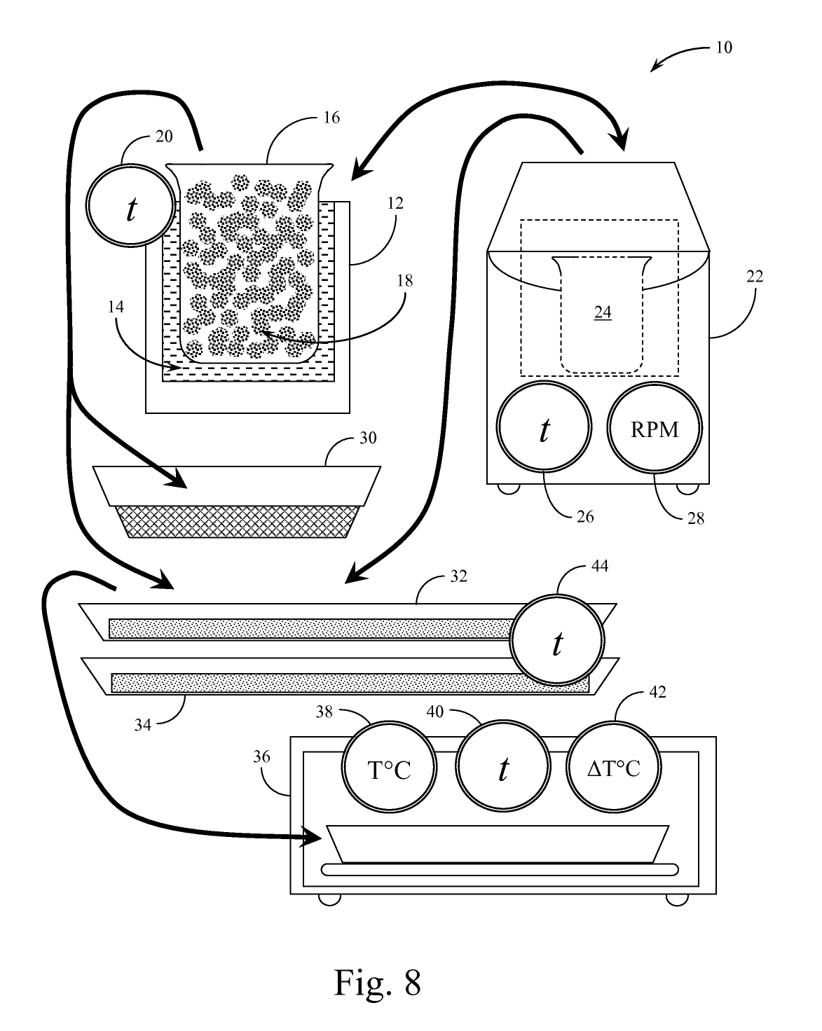

Reference is next made to FIG. 8 which is a partially schematic diagram disclosing the various instruments and manufacturing system components 10 that are required for the manufacturing process of the present invention. These components include a sonicator 12, preferably a bath 14 type sonicator within which may be partially immersed a beaker 16 containing either the slurry solutions or the combination of the treated foam material and the slurry solution 18. The primary measure associated with operation of the sonicator is a time variable 20 dependent upon the effectiveness of the removal of bubbles from the solutions and the coating of the granules with the slurry solution.

The mixer 22 utilized in the method of the present invention is preferably a dual action mixer that provides two rotational motions to the container 24 (preferably a closed mixing container) so as to facilitate the smooth and complete mixing of the material. It is preferable that no mixing blade or other invasive device be utilized in the mixer in order to prevent loss of slurry and physical damage of the granules. The mixing is achieved by the rotational forces associated with movement of the mixing container within the mixer according to two different rotational paths. The parameters associated with the dual action mixer include both a time variable 26 and a rotations per minute, or rpm variable 28.

Various types of drying structures are utilized for a specific period of time 44 in the present invention, including porous surfaces 32 that allow excess slurry material to drain away from the granules, and sieves 30 that similarly allow excess slurry material to drain away, and allow a flow of air to facilitate the excess slurry separation. A further high temperature tray 34 (preferably made of alumina) is utilized in the sintering cycle process of the method of the present invention. A programmable sintering oven 36 is utilized that is capable of not only achieving the elevated temperatures required for the sintering process, but also controlling the temperature and the rate of change of the temperature in an accurate manner. The parameters associated with the oven are therefore the temperature 38 within the oven, the time duration 40 of the maintenance of the temperature within the oven, and a carefully controlled rate of change of temperature 42 within the oven (both increasing and decreasing in temperature).

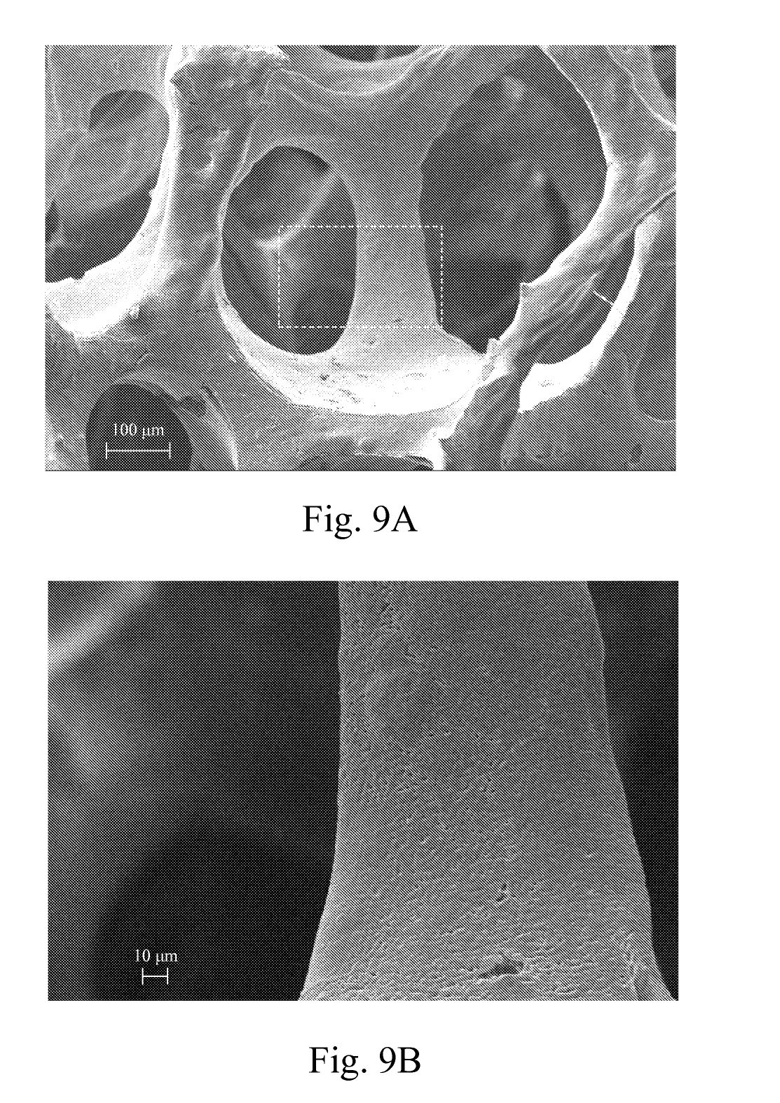

FIG. 9A is an image of the open-pore structure of the implant of the present invention showing the fully reticulated trabecular struts. FIG. 9B is a close-up image of a section of the surface of the implant of FIG. 9A, showing the individual hydroxyapatite particles fused together to form a mechanically strong scaffold.

Although the present invention has been described in terms of the foregoing preferred embodiments, this description has been provided by way of explanation only, and is not intended to be construed as a limitation of the invention. Those skilled in the art will recognize modifications of the present invention that might accommodate specific applications and tissue requirements. Those skilled in the art will further recognize additional methods for modifying the composition and construction to accommodate these variations in tissue requirements. Such modifications, as to size structure, orientation, geometry, and even composition and construction techniques, where such modifications are coincidental to the type of product material required, do not necessarily depart from the spirit and scope of the invention.

I claim:

1. A method for manufacturing porous sintered ceramic structures comprising the steps of:
(a) preparing a porous body of polymer foam by sizing the foam into objects of desired dimensions, immersing the foam objects in a cleaning solution, sonicating, rinsing with distilled water, compressing, and drying to form prepared foam objects;
(b) preparing a first slurry of ceramic particle suspension by combining a ceramic powder, a polymer solution, and at least one binding agent, adding a dispersant, mixing, adding a drying agent, sonicating, and mixing further;
(c) carrying out a first coating process using a mixer to coat the prepared foam objects uniformly with the first slurry and subsequently subjecting the coated prepared foam objects to a flow of air to clear excess slurry from the pores of the prepared foam objects, followed by drying the ceramic coated prepared foam objects;
(d) heating the coated prepared foam objects through a sintering cycle at temperatures sufficient to burn off and release the at least one binding agent, the dispersant, and the polymer foam material and to convert the ceramic coated prepared foam objects into coalesced porous sintered ceramic structures;
(e) preparing a second slurry of ceramic particle suspension by combining a ceramic powder, a polymer solution, and the at least one binding agent, adding a dispersant, mixing, adding a drying agent, sonicating, and mixing further;
(f) carrying out a second coating process by combining the second slurry and the coalesced porous sintered ceramic structures, agitating the coalesced porous sintered ceramic structures with the second slurry and subsequently subjecting the coated porous sintered ceramic structures to a flow of air to clear excess slurry from the pores of the coated porous sintered ceramic structures, followed by drying the coated porous sintered ceramic structures; and
(g) heating the coated porous sintered ceramic structures through a sintering cycle at temperatures sufficient to burn off and release the at least one binding agent and the dispersant, to leave finalized porous sintered ceramic structures.

2. Porous sintered ceramic structures produced according to the method of claim 1.

3. The method for manufacturing porous sintered ceramic structures as set forth in claim 1, wherein the ceramic powders are selected from the group consisting of: hydroxyapatite, tricalcium phosphate, amorphous calcium phosphate, monocalcium phosphate, dicalcium phosphate, octacalcium phosphate, tetracalcium phosphate, calcium sulfate, aluminum oxide, silicon dioxide, and zirconium oxide.

4. The method for manufacturing porous sintered ceramic structures as set forth in claim 1, wherein the ceramic powder of the second slurry is different than the ceramic powder of the first slurry.

5. The method for manufacturing porous sintered ceramic structures as set forth in claim 1, wherein the polymer solutions are selected from the group consisting of: polyvinyl alcohol, carboxymethylcellulose, starch, polyvinyl butyral, and polyethylene glycol.

6. The method for manufacturing porous sintered ceramic structures as set forth in claim 1, wherein the polymer solution of the second slurry is different than the ceramic powder of the first slurry.

7. The method for manufacturing porous sintered ceramic structures as set forth in claim 1, wherein the dispersant comprises ammonium polyacrylate or ammonium polymethacrylate.

8. The method for manufacturing porous sintered ceramic structures as set forth in claim 1, wherein the drying agent comprises dimethylformamide or dimethylsulfoxide.

9. The method for manufacturing porous sintered ceramic structures as set forth in claim 1, wherein the cleaning solution comprises an aqueous solution of pH 9 to pH 14 and further wherein the aqueous solution is selected from the group consisting of: sodium hydroxide, ammonium hydroxide, and potassium hydroxide.

10. The method for manufacturing porous sintered ceramic structures as set forth in claim 1, wherein the pores of the finalized porous sintered ceramic structures range in size from 100 to 500 microns.

11. The method for manufacturing porous sintered ceramic structures as set forth in claim 1, wherein the porous body of polymer foam comprises at least one material selected from the group consisting of: polyurethane foam and vinyl polymer foam.

12. The method for manufacturing porous sintered ceramic structures as set forth in claim 1, wherein the step of mixing comprises mixing with a dual action mixer.

13. The method for manufacturing porous sintered ceramic structures as set forth in claim 1, wherein the heating steps comprise holding at a temperature between 1200 and 1600° C. for 2 to hours.

14. The method for manufacturing porous sintered ceramic structures as set forth in claim 1, wherein the heating steps comprise holding at a temperature equal to or greater than the transition temperature of the ceramic powder.

15. The method for manufacturing porous sintered ceramic structures as set forth in claim 1, wherein the finalized porous sintered ceramic structures range in size from 0.5 mm to 2000 mm. and the shape comprises one or more shapes selected from the group consisting of spherical, cuboidal, star-shaped, egg-shaped, cylindrical, plates, and screws.

16. The method for manufacturing porous sintered ceramic structures as set forth in claim 1, wherein the polymer foam used for making the porous sintered ceramic structures comprises different foams of varying pore size and composition.
